(19) United States
(12) Patent Application Publication
(10) Pub. No.: US 2019/0127526 A1
(43) Pub. Date: May 2, 2019

(54) Antioxidant Polymeric Diphenylamine Compositions

(71) Applicant: BASF SE, Carl Bosch Strasse (DE)

(72) Inventors: Liehpao Oscar Farng, Lawrenceville, NJ (US); Graciela Sanchez Jimenez, Puebla (MX); Mary Dery, Putnam Valley, NY (US); Paul Odorisio, Leonia, NJ (US); Bridgett Rakestraw, Brewster, NY (US); Sai Shum, Pleasantville, NY (US); David Khoshabo, Bethel, CT (US); Michael L. Alessi, Rose Valley, PA (US); Rebecca Cristine Vieira, Morristown, NJ (US); Andrew Edmund Taggi, New Hope, PA (US)

(21) Appl. No.: 16/175,267

(22) Filed: Oct. 30, 2018

Related U.S. Application Data
(60) Provisional application No. 62/579,625, filed on Oct. 31, 2017.

(51) Int. Cl. C08G 73/02; C10M 149/22

(52) U.S. Cl. CPC C08G 73/026; C10N 2230/10; C10M 2217/046; C10M 149/22

(57) ABSTRACT

An antioxidant polymer (e.g., oligomer) composition comprising repeat units of diphenylamine monomers of formula I

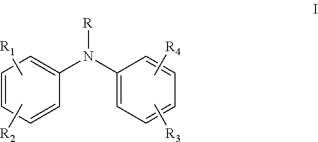

wherein R is H, C₁-C₁₈ alkyl, C₂-C₁₈ alkenyl, C₂-C₁₈ alkynyl, —C(O)C₁-C₁₈ alkyl, —C(O)aryl and R₁, R₂, R₃ and R₄ are each independently H or a linear or branched C₁-C₁₈ alkyl, C₁-C₁₈ alkoxy, C₁-C₁₈ alkylamino, C₁-C₁₈ dialkylamino, C₁-C₁₈ alkylthio, C₂-C₁₈ alkenyl, C₂-C₁₈ alkynyl or C₇-C₂₁ aralkyl and wherein the number average molecular weight (Mn) of the polymer is from about 350 g/mol to about 5000 g/mol are highly effective antioxidants in lubricant compositions. The polymer compositions may be prepared by a process comprising subjecting diarylamine monomers to dehydrocondensation conditions.

### RELATED APPLICATION

This application claims priority to U.S. Provisional Patent Application No. 62/579,625, filed on Oct. 31, 2017, which is herein incorporated by reference in its entirety.

### TECHNICAL FIELD

The present disclosure is directed to antioxidant diphenylamine polymer (e.g., oligomer) compositions. The antioxidant polymer compositions are suitable towards providing lubricant compositions viscosity control and deposits control.

### BACKGROUND

Lubricant oxidative stability is one of the key parameters controlling oil life, which translates to oil drain interval in practical terms. Additionally, deposit formation is an issue associated with the decomposition of the base stock molecules mostly propagated by oxidative chain reactions. There are several conventional approaches to improve the resistance to oxidation of a finished lubricant product, but most products are formulated using small molecules such as diphenylamine (DPA) or a phenolic antioxidant.

Improved oxidation stability is necessary to increase oil life and oil drain intervals, thus reducing the amount of used oil generated as a consequence of more frequent oil changes. Longer oil life and oil drain intervals are key benefits that are desirable to end customers. Traditional antioxidant packages provide standard protection leaving the main differentiation hinging on the quality of the base stock in the formulation.

What is needed are newly designed lubricants capable of controlling oxidation and oil thickening for longer periods of time as compared to conventional lubricants. Further, what are needed are newly designed lubricants that enable extended oil life in combination with desired deposit control and cleanliness performance.

### SUMMARY

In certain embodiments, the disclosure is directed to an antioxidant polymer (e.g., oligomer) composition comprising repeat units of diphenylamine monomers of formula I

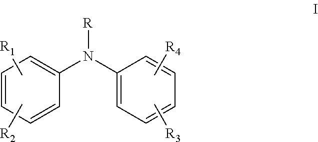

wherein R is H, C₁-C₁₈ alkyl, C₂-C₁₈ alkenyl, C₂-C₁₈ alkynyl, —C(O)C₁-C₁₈ alkyl, —C(O)aryl; and R₁, R₂, R₃ and R₄ are each independently H or a linear or branched C₁-C₁₈ alkyl, C₁-C₁₈ alkoxy, C₁-C₁₈ alkylamino, C₁-C₁₈ dialkylamino, C₁-C₁₈ alkylthio, C₂-C₁₈ alkenyl, C₂-C₁₈ alkynyl or C₇-C₂₁ aralkyl. In certain embodiments, the number average molecular weight (Mn) of the antioxidant polymer (e.g., oligomer) composition is at least about 350 g/mol or from about 350 g/mol to about 5000 g/mol.

Also disclosed in certain embodiments is an antioxidant polymer (e.g., oligomer) composition comprising repeat units of diphenylamine monomers of formula I, wherein the composition comprises ≤about 99 wt %, ≤about 90 wt %, ≤about 80 wt %, ≤about 70 wt %, ≤about 65 wt %, ≤about 60 wt %, ≤about 55 wt %, ≤about 50 wt %, ≤about 45 wt %, ≤about 40 wt %, ≤about 35 wt %, ≤about 30 wt %, ≤about 25 wt %, ≤about 20 wt %, ≤about 15 wt %, ≤about 10 wt %, ≤about 5 wt %, ≤about 1 wt %, ≤about 0.5 wt %, ≤about 0.1 wt %, ≤about 0.05 wt % or ≤about 0.01 wt % residual monomers of formula I. For example, in certain embodiments, disclosed is an antioxidant polymer (e.g., oligomer) composition comprising repeat units of diphenylamine monomers of formula I, wherein the composition comprises from any one of about 0.01 wt %, about 0.05 wt %, about 0.1 wt %, about 0.5 wt %, about 1 wt %, about 2 wt % , about 3 wt %, about 4 wt %, about 5 wt %, about 7 wt %, about 9 wt %, ab about 70 wt %out 11 wt % or about 13 wt % to any one of about 15 wt %, about 18 wt %, about 21 wt %, about 24 wt %, about 27 about 70 wt % wt %, about 30 wt %, about 35 wt %, about 40 wt %, about 45 wt %, about 50 wt %, about 55 wt %, about 60 wt %, about 65 wt %, about 70 wt %, about 80 wt % or about 99 wt % residual monomers of formula I, based on the total weight of the antioxidant composition.

Also disclosed in certain embodiments is a process for preparing the antioxidant polymer (e.g., oligomer) composition, the process comprising subjecting one or more diphenylamine monomers of formula

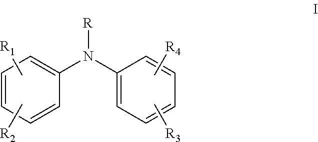

wherein R is H, C₁-C₁₈ alkyl, C₂-C₁₈ alkenyl, C₂-C₁₈ alkynyl, —C(O)C₁-C₁₈ alkyl, —C(O)aryl; and R₁, R₂, R₃ and R₄ are each independently H or a linear or branched C₁-C₁₈ alkyl, C₁-C₁₈ alkoxy, C₁-C₁₈ alkylamino, C₁-C₁₈ dialkylamino, C₁-C₁₈ alkylthio, C₂-C₁₈ alkenyl, C₂-C₁₈ alkynyl or C₇-C₂₁ aralkyl.; to dehydrocondensation conditions. Also disclosed are products prepared by the processes disclosed herein.

### DETAILED DESCRIPTION

In certain embodiments, the present disclosure is directed to an antioxidant polymer (e.g., oligomer) composition comprising repeat units of diphenylamine monomers of formula I

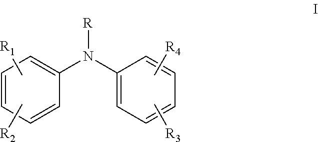

wherein R is H, C₁-C₁₈ alkyl, C₂-C₁₈ alkenyl, C₂-C₁₈ alkynyl, —C(O)C₁-C₁₈ alkyl, —C(O)aryl; and R₁, R₂, R₃ and R₄ are each independently H or a linear or branched C₁-C₁₈ alkyl, C₁-C₁₈ alkoxy, C₁-C₁₈ alkylamino, C₁-C₁₈ dialkylamino, C₁-C₁₈ alkylthio, C₂-C₁₈ alkenyl, C₂-C₁₈ alkynyl or C₇-C₂₁ aralkyl. In certain embodiments, the degree of polymerization (e.g., oligomerization) is such that an antioxidant polymer (e.g., oligomer) composition has a number average molecular weight (Mn) of at least about 350 g/mol or from about 350 g/mol to about 5000 g/mol.

In other embodiments, the antioxidant polymer (e.g., oligomer) compositions of the disclosure have an Mn of from about 900 g/mol or about 1000 g/mol to about 1200 g/mol or an Mn of any one of from about 400 g/mol, about 430 g/mol, about 460 g/mol, about 490 g/mol, about 520 g/mol, about 550 g/mol, about 580 g/mol, about 610 g/mol, about 640 g/mol, about 670 g/mol, about 700 g/mol or about 730 g/mol g/mol to any one of about 760 g/mol, about 790 g/mol, about 820 g/mol, about 850 g/mol, about 880 g/mol, about 910 g/mol, about 940 g/mol, about 970 g/mol, about 1000 g/mol, about 1030 g/mol, about 1060 g/mol, about 1090 g/mol, about 1120 g/mol, about 1150 g/mol, about 1180 g/mol, about 1210 g/mol, about 1240 g/mol, about 1270 g/mol, about 1300 g/mol, about 1400 g/mol, about 1500 g/mol, about 1600 g/mol, about 1700 g/mol, about 2000 g/mol, about 2100 g/mol, about 2200 g/mol, about 2300 g/mol, about 2400 g/mol, about 2500 g/mol, about 3000 g/mol, about 3500 g/mol, about 4000 g/mol, about 4500 g/mol or about 5000 g/mol.

The number average molecular weight can be determined, for example, by gel permeation chromatography (GPC) techniques with a polystyrene standard. GPC conditions may include testing relative to a set of polystyrene standards (EasiCal PS-1, low and high and PS162). Samples are prepared in tetrahydrofuran (THF) and duplicate injections of solutions are run. Similar conditions may also be employed.

In certain embodiments, less than about 25 percent by weight of the composition contains molecules having a molecular weight of less than about 1000 g/mol.

In certain embodiments, the present disclosure is directed to an antioxidant polymer (e.g., oligomer) composition comprising repeat units of diphenylamine monomers of formula II

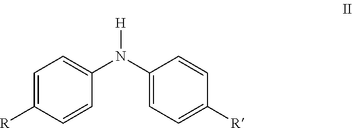

wherein R and R′ are each independently H or a linear or branched C₁-C₁₈ alkyl, C₂-C₁₈ alkenyl or C₇-C₂₁ aralkyl. In certain embodiments, R and R′ are each independently H, tert-butyl or tert-octyl.

Linear or branched alkyl includes methyl, ethyl, propyl, isopropyl, n-butyl, sec-butyl, isobutyl, tert-butyl, 2-ethylbutyl, n-pentyl, isopentyl, 1-methylpentyl, 1,3-dimethylbutyl, n-hexyl, 1-methylhexyl, n-heptyl, isoheptyl, 1,1,3,3-tetramethylbutyl, 1-methylheptyl, 3-methylheptyl, n-octyl, tert-octyl, 2-ethylhexyl, 1,1,3-trimethylhexyl, 1,1,3,3-tetramethylpentyl, nonyl, decyl, undecyl, 1-methylundecyl, dodecyl, 1,1,3,3,5,5-hexamethylhexyl, tridecyl, tetradecyl, pentadecyl, hexadecyl, heptadecyl and octadecyl. Alkyl groups mentioned herein are linear or branched.

The alkyl portion of alkoxy, alkylamine, dialkylamino and alkylthio groups are linear or branched and include the alkyl groups mentioned above.

Alkenyl is an unsaturated alkyl, for instance allyl. Alkynyl includes a triple bond.

Aralkyl includes benzyl, α-methylbenzyl, α,α-dimethylbenzyl and 2-phenylethyl.

Diphenylamine antioxidants are commercially available, for example under the trade names IRGANOX L57, IRGANOX L67 and IRGANOX L01.

In certain embodiments, the antioxidant polymer (e.g., oligomer) compositions of the disclosure can be prepared by a process comprising subjecting diphenylamine monomers of formula I

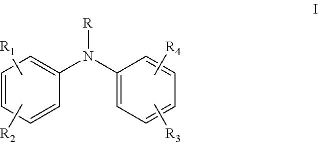

Wherein R is H, C₁-C₁₈ alkyl, C₂-C₁₈ alkenyl, C₂-C₁₈ alkynyl, —C(O)C₁-C₁₈ alkyl, —C(O)aryl; and R₁, R₂, R₃ and R₄ are each independently H or a linear or branched C₁-C₁₈ alkyl, C₁-C₁₈ alkoxy, C₁-C₁₈ alkylamino, C₁-C₁₈ dialkylamino, C₁-C₁₈ alkylthio, C₂-C₁₈ alkenyl, C₂-C₁₈ alkynyl or C₇-C₂₁ aralkyl to dehydrocondensation conditions.

Dehydrocondensation conditions comprise exposing monomers of formula I to oxidative conditions, for example, by exposure to a compound capable of forming free radicals. Compounds capable of forming free radicals include inorganic and organic peroxides, such as di-t-butylperoxide and di-t-amylperoxide. The dehydrocondensation reaction may be performed neat, that is, without added solvent, or may be performed in the presence of a solvent. Suitable solvents include alkanes such as hexane, heptane, octane, nonane, decane, undecane or dodecane. Dehydrocondensation may be performed in the presence of a base stock (e.g., ester, mineral, synthetic, GTL or alkyl naphthalene base stocks).

In some embodiments, the dehydrocondensation conditions comprise reaction temperatures of any one of from about 40° C., about 60° C., about 80° C., about 100° C., about 120° C., about 140° C. or about 160° C. to any one of about 180° C., about 200° C., about 220° C., about 240° C. or about 250° C.

In certain embodiments, the dehydrocondensation conditions comprise a reaction time of from any one of from about 0.3 hours, about 0.5 hour, about 1 hour, about 2 hours, about 3 hours, about 4 hours, about 5 hours or about 6 hours to any one of about 7 hours, about 8 hours, about 9 hours, about 10 hours, about 11 hours or about 12 hours. In other embodiments, the dehydrocondensation conditions may comprise a reaction time of from any one of about 12 hours, about 24 hours, about 36 hours, about 48 hours or about 60 hours to any one of about 72 hours, about 84 hours, about 96 hours, about 108 hours or about 120 hours.

The oxidative conditions remove hydrogen from the monomers, which subsequently couple through C—N, C—C or N—N bonds. When an alkane solvent is used, the solvent appears to be inert and to not be involved in the reaction. Therefore, the produced polymer (e.g., oligomer) may contain no alkane solvent fragments.

The term “oligomer comprising repeat units of diphenylamine monomers” means the oligomers contain “reacted in” monomers, that is, radicals of monomers.

In certain embodiments, antioxidant polymer (e.g., oligomer) compositions of the present disclosure provide lubricating oil compositions an improvement in at least one of viscosity control and deposits prevention as compared to a lubricating oil composition that does not contain the polymers (e.g., oligomers) of the present disclosure.

Viscosity control and deposit prevention may be determined by industry standard tests, for instance a TEOST MHT 4 test (ASTM D7097) bench test or Sequence IIIH Test (ASTM D8111) engine test. Tests may be modified to increase the severity, for example by increasing temperature and/or time of a test.

In some embodiments, the lubricating oil compositions of the present disclosure exhibits color according to ASTM D1500 of any one of about 3.5, about 4.0, about 4.5, about 5.0, about 5.5 or about 6.0. In certain embodiments, the lubricating oil compositions exhibit color according to ASTM D1500 of ≤6.0. In certain embodiments, the lubricating oil compositions of the present disclosure exhibit a lower color according to ASTM D1500 relative to compositions containing other polymeric aminic antioxidants, for example relative to compositions containing polymeric phenylnaphthylamine antioxidants.

The antioxidant polymer (e.g., oligomer) compositions of the present disclosure may contain a mixture of different chain lengths. For example, the composition may contain residual unreacted monomer as well as fragments or chains having molecular weights above or below the ranges mentioned above. Residual monomer means unreacted monomer. The polymer (e.g., oligomer) composition may be purified, for example by a step comprising chromatography or distillation. In one embodiment, the produced polymer (e.g., oligomer) composition may be subject to reduced pressure to remove residual monomer.

Also disclosed in certain embodiments is an polymer (e.g., oligomer) composition comprising repeat units of diphenylamine monomers of formula I, wherein the composition comprises ≤about 99 wt %, ≤about 90 wt %, ≤about 80 wt %, ≤about 70 wt %, ≤about 65 wt %, ≤about 60 wt %, ≤about 55 wt %, ≤about 50 wt %, ≤about 45 wt %, ≤about 40 wt %, ≤about 35 wt %, ≤about 30 wt %, ≤about 25 wt %, ≤about 20 wt %, ≤about 15 wt %, ≤about 10 wt % ≤about 5 wt %, ≤about 1 wt %, ≤about 0.5 wt %, ≤about 0.1 wt %, ≤about 0.05 wt % or ≤about 0.01 wt % residual monomers of formula I, based on the weight of the composition. For example, in certain embodiments, disclosed is an polymer (e.g., oligomer) composition comprising repeat units of diphenylamine monomers of formula I, wherein the composition comprises from any one of about 0.01 wt %, about 0.05 wt %, about 0.1 wt %, about 0.5 wt %, about 1 wt %, about 2 wt % , about 3 wt %, about 4 wt %, about 5 wt %, about 7 wt %, about 9 wt %, about 11 wt % or about 13 wt % to any one of about 15 wt %, about 18 wt %, about 21 wt %, about 24 wt %, about 27 wt %, about 30 wt %, about 35 wt %, about 40 wt %, about 45 wt %, about 50 wt %, about 55 wt %, about 60 wt %, about 65 wt % about 70 wt %, about 80 wt % or about 99 wt % residual monomers of formula I, based on the total weight of the antioxidant polymer (e.g., oligomer) composition.

In certain embodiments, the purification steps to remove residual monomers includes subjecting the polymer (e.g., oligomer) composition to reduced pressure. In certain embodiments, the remaining monomer in the composition will include higher molecular weight monomers, e.g. di- or tri-alkyl substituted monomers. In some embodiments, wherein the polymer (e.g., oligomer) composition contains residual monomer, from any one of about 90 wt %, about 91 wt %, about 92 wt %, about 93 wt %, about 94 wt % or about 95 wt % to any one of about 96 wt %, about 97 wt %, about 98 wt %, about 99 wt % or 100 wt % of the residual monomer is of formula I wherein R₁ and R₄ are independently C₄-C₁₈ alkyl, C₄-C₁₈ alkenyl or C₇-C₂₁ aralkyl, based on the total weight of residual monomer.

In certain embodiments, the polymer (e.g., oligomer) composition may also be characterized by its viscosity. For example, the present antioxidant polymer (e.g., oligomer) compositions of the disclosure may have a kinematic viscosity at 100° C. of about 10 cSt to about 2,500 cSt. In other embodiments, the kinematic viscosity at 100° C. may be from any one of about 10 cSt, about 20 cSt, about 30 cSt, about 40 cSt, about 50 cSt, about 60 cSt, about 70 cSt, about 80 cSt, about 81 cSt, about 82 cSt, about 83 cSt, about 84 cSt, about 85 cSt, about 86 cSt, about 87 cSt, about 88 cSt, about 89 cSt, about 90 cSt, about 91 cSt, about 92 cSt, about 93 cSt, about 94 cSt, about 95 cSt, about 96 cSt, about 97 cSt, about 98 cSt or about 99 cSt to any one of about 100 cSt, about 101 cSt, about 102 cSt, about 103 cSt, about 104 cSt, about 105 cSt, about 106 cSt, about 107 cSt, about 108 cSt, about 109 cSt, about 110 cSt, about 111 cSt, about 112 cSt, about 113 cSt, about 114 cSt, about 115 cSt, about 116 cSt, about 117 cSt, about 118 cSt, about 119 cSt , about 120 cSt, about 500 cSt, about 1,000 cSt, about 1,500 cSt, about 2,000 cSt or about 2,500 cSt.

In certain other embodiments of the disclosure, the antioxidant polymer (e.g., oligomer) compositions may have a kinematic viscosity at 100° C. of from any one of about 120 cSt, about 140 cSt, about 170 cSt, about 190 cSt, about 210 cSt, about 230 cSt, about 260 cSt, about 310 cSt or about 360 cSt to any one of about 400 cSt, about 420 cSt, about 450 cSt, about 470 cSt, about 500 cSt, about 530 cSt, about 570 cSt or about 600 cSt. In certain other embodiments, the polymer (e.g., oligomer) compositions may be solids.

Viscosity may be determined according to ASTM D445 or equivalent or similar methods measured at 100° C.

In certain embodiments, further monomers may be included in the polymerization reaction. For example, present polymer (e.g., oligomer)s may contain one or more monomers selected from the group consisting of other diphenylamines, phenothiazines, phenoxazines, aminodiphenylamines, methylenedianiline, toluenediamine, aminophenols, alkylphenols, thiophenols, phenylenediamines, quinolines, phenyl pyridinediamines, pyridinepyrimidinediamines, naphthylphenylamines and phenylpyrimidinediamines.

In some embodiments, present polymer (e.g., oligomer) compositions comprise from any one of about 1 mol %, 10 mol %, about 20 mol %, about 30 mol %, about 40 mol % or about 50 mol % to any one of about 60 mol %, about 70 mol %, about 80 mol %, about 90 mol %, about 95 mol %, about 96 mol %, about 97 mol %, about 98 mol %, about 99 mol % or 100 mol % diphenylamine monomers of formula I.

In certain embodiments, the polymeric compositions disclosed herein are oligomeric compositions (i.e., dimers, trimers and tetramers).

In certain embodiments, the polymeric compositions disclosed herein comprise one or more of dimers, trimers, tetramers or higher repeating units (i.e. a polymer of 5 or more monomers).

In certain embodiments, the polymeric compositions have an amount of dimers that are greater than the amount of higher repeating units.

In certain embodiments, the polymeric compositions have an amount of trimers that are greater than the amount of higher repeating units.

In certain embodiments, the polymeric compositions have a combined amount of dimers and trimers that are greater than the amount of higher repeating units.

In certain embodiments, the polymeric compositions have at least 75% Mn of greater than 1000. In other embodiments, the polymeric compositions have about 10% to about 100%, about 20% to about 80%, about 25% to about 75%, about 30% to about 70% or about 40% to about 60% Mn of greater than 1000.

In certain embodiments, the polymeric compositions have at least 75% Mn of less than 1000. In other embodiments, the polymeric compositions have about 20% to about 80%, about 25% to about 75%, about 30% to about 70% or about 40% to about 60% Mn of less than 1000.

In certain embodiments, the polymeric compositions have an amount of dimers of from any one of about 5%, about 10%, about 15%, about 20%, about 25% or about 30% to any one of about 40%, about 45%, about 50%, about 55%, about 60%, about 70%, about 80%, about 90% or about 100%. In certain embodiments, the dimers have a number average molecular weight (Mn) of about 300 to about 850.

In certain embodiments, the polymeric compositions have an amount of trimers of from any one of about 10%, about 15%, about 20%, about 25%, about 30% or about 40% to any one of about 50%, about 55%, about 60%, about 65%, about 70%, about 80%, about 90% or about 100%. In certain embodiments, the trimers have a number average molecular weight (Mn) of about 400 to about 1200.

In certain embodiments, the polymeric compositions have an amount of tetramers of from any one of about 15%, about 20%, about 25%, about 30%, about 40% or about 50% to any one of about 55%, about 60%, about 65%, about 70%, about 75%, about 80%, about 90% or about 100%. In certain embodiments, the tetramers have a number average molecular weight (Mn) of about 500 to about 1500.

In certain embodiments, the polymeric compositions have an amount of higher repeating units of from any one of about 5%, about 10%, about 25%, about 30%, about 40% to any one of about 50%, about 60%, about 70%, about 80%, about 90% or about 100%. In certain embodiments, the higher repeating units have a number average molecular weight (Mn) of greater than about 1000 or greater than about 1174.

In certain embodiments polymeric composition have m/z ions ranging from 300 to 1000. In certain embodiments, the above m/z ions include 838 Daltons, 894 Daltons or 911 Daltons.

In certain embodiments, the polymeric compositions have an m/z ion count from about 300 to about 1,000 of greater than about 50, greater than about 75, greater than about 100, greater than about 150, greater than about 200, greater than about 250, greater than about 300 or greater than about 350. In certain embodiments, the polymeric compositions have an m/z ion count from about 800 to about 1,000 of from any one of about 50, about 75, about 100 or about 150 to any one of about 200, about 250, about 300 or about 350.

In certain embodiments, the polymeric compositions exhibit a VIT(h) of greater than about 600, greater than about 650, greater than about 700, or greater than about 850. In certain embodiments, the polymeric compositions exhibit a VIT(h) of from any one of about 600, about 650, or about 700 to any one of about 900, about 1,200 or about 1,500. A comparator monomer composition provides a VIT(h) of 472. The VIT test is performed by placing a sample of formulated oil in a glass tube with a homogeneous catalyst consisting of iron, copper and lead. Air is bubbled through the sample at a rate of 8 L/h and heated to 150° C. The kinematic viscosity (KV40) is monitored throughout the test, and the data fit to a power curve to calculate the time, in hours, it takes for the sample to reach 150% of its original KV40.

In certain embodiments, disclosed is a grease formulation that provides a value of greater than 100, greater than 110 or greater than 120 when tested according to DIN 51821 FAG FE9 AFAG FE9 A/1500/6000@140 C (B50, hours) when the grease formulation comprises 1% of the disclosed polymer composition.

In certain embodiments, disclosed is an industrial oil formulation that provides a value of greater than 2000, greater than 2025 or greater than 2050 when tested according to ASTM D2272-RPVOT at 150 C (min) when the industrial oil formulation comprises 1% of the disclosed polymer composition.

In certain embodiments, disclosed is an industrial oil formulation that provides a value of greater than 2100, greater than 2200 or greater than 2500 when tested according to ASTM D2272-RPVOT at 150 C (min) when the industrial oil formulation comprises 0.7% of the disclosed polymer composition.

In certain embodiments, disclosed is an industrial oil formulation that provides a value of greater than 225, greater than 230 or greater than 235 when tested according to High Pressure Differential Scanning Calorimetry (min) when the industrial oil formulation comprises 1% of the disclosed polymer composition.

In certain embodiments, disclosed is an industrial oil formulation that provides a value of greater than 50, greater than 65 or greater than 80 when tested according to High Pressure Differential Scanning Calorimetry (min) when the industrial oil formulation comprises 0.7% of the disclosed polymer composition.

In certain embodiments, disclosed is a passenger vehicle lubricant formulation that provides a value of less than 52, less than 46 or less than 40 when tested according to ASTM D7097-TEOST MHT4 (Total deposits, mg) when the passenger vehicle lubricant formulation comprises 2% of the disclosed polymer composition.

In certain embodiments, disclosed is a passenger vehicle lubricant formulation that provides a value of less than 35, less than 34 or less than 32 when tested according to ASTM D6335-TEOST 33C (Total deposits, mg) when the passenger vehicle lubricant formulation comprises 2% of the disclosed polymer composition.

In certain embodiments, disclosed is a passenger vehicle lubricant formulation that provides a value of less than 400, less than 300, less than 200, less than 150 or less than 75 when tested according to ASTM D8111-Sequence IIIH, EOT % Viscosity increase when the passenger vehicle lubricant formulation comprises 2% of the disclosed polymer composition.

In certain embodiments, disclosed is a passenger vehicle lubricant formulation that provides a value of greater than 4.8, greater than 4.9, greater than 5.0 or greater than 5.1 when tested according to ASTM D8111-Sequence IIIH, Weighted Piston Deposit Merits when the passenger vehicle lubricant formulation comprises 2% of the disclosed polymer composition.

In certain embodiments, disclosed is a passenger vehicle lubricant formulation that provides a value of greater than 9.7, greater than 9.75 or greater than 9.8 when tested according to ASTM D8111-Sequence IIIH, Average Piston Varnish Merits when the passenger vehicle lubricant formulation comprises 2% of the disclosed polymer composition.

In certain embodiments, disclosed is a commercial vehicle lubricant formulation that provides a value of less than 145, less than 135 or less than 125 when tested according to ASTM D8048-Volvo T-13, IR Peak Increase when the commercial vehicle lubricant formulation comprises 1.4% of the disclosed polymer composition.

The polymeric (e.g., oligomeric) antioxidant compositions are suitable for use for instance in lubricating oil formulations. Lubricating oil formulations include but are not limited to greases, gear oils, hydraulic oils, brake fluids, manual and automatic transmission fluids, other energy transferring fluids, tractor fluids, diesel compression ignition engine oils, gasoline spark ignition engine oils, turbine oils and the like. The lubricating base oil may be selected from the group consisting of natural oils, petroleum-derived mineral oils, synthetic oils and mixtures thereof.

Lubricating base oils include natural or synthetic oils and unconventional oils of lubricating viscosity; typically those oils having a kinematic viscosity at 100° C. in the range of any one of about 2 cSt, about 4 cSt or about 8 cSt to about 25 cSt, about 50 cSt or about 100 cSt.

Natural oils include animal oils, vegetable oils (castor oil and lard oil, for example), and mineral oils. Of the natural oils, mineral oils are preferred. Mineral oils vary widely as to their crude source, for example, as to whether they are paraffinic, naphthenic, or mixed paraffinic-naphthenic. Oils derived from coal or shale are also useful in the present disclosure.

Synthetic oils include hydrocarbon oils as well as non hydrocarbon oils. Synthetic oils can be derived from processes such as chemical combination (for example, polymerization, oligomerization, condensation, alkylation, acylation, etc.), where materials consisting of smaller, simpler molecular species are built up (i.e., synthesized) into materials consisting of larger, more complex molecular species. Synthetic oils include hydrocarbon oils such as polymerized and interpolymerized olefins (polybutylenes, polypropylenes, propylene isobutylene copolymers, ethylene-olefin copolymers and ethylene-alphaolefin copolymers, for example). Polyalphaolefins (PAOs) base stocks are commonly used as synthetic hydrocarbon oil. For example, PAOs derived from C₈, C₁₀, C₁₂, C₁₄ olefins or mixtures thereof may be utilized. See for example U.S. Pat. Nos. 4,956,122; 4,827,064; and 4,827,073.

A base stock may comprise esters. Additive solvency and seal compatibility characteristics may be secured by the use of esters such as the esters of dibasic acids with monoalkanols and the polyol esters of monocarboxylic acids. Esters of the former type include, for example, the esters of dicarboxylic acids such as phthalic acid, succinic acid, alkyl succinic acid, alkenyl succinic acid, maleic acid, azelaic acid, suberic acid, sebacic acid, fumaric acid, adipic acid, linoleic acid dimer, malonic acid, alkyl malonic acid, alkenyl malonic acid, etc., with a variety of alcohols such as butyl alcohol, hexyl alcohol, dodecyl alcohol, 2-ethylhexyl alcohol, etc. Specific examples of these types of esters include dibutyl adipate, di(2-ethylhexyl) sebacate, di-n-hexyl fumarate, dioctyl sebacate, diisooctyl azelate, diisodecyl azelate, dioctyl phthalate, didecyl phthalate, dieicosyl sebacate, etc.

In certain embodiments, useful synthetic esters may be those which are obtained by reacting one or more polyhydric alcohols, preferably the hindered polyols (such as the neopentyl polyols, e.g., neopentyl glycol, trimethylol ethane, 2-methyl-2-propyl-1,3-propanediol, trimethylol propane, pentaerythritol and dipentaerythritol) with alkanoic acids containing at least 4 carbon atoms, preferably C₅ to C₃₀ acids such as saturated straight chain fatty acids including caprylic acid, capric acid, lauric acid, myristic acid, palmitic acid, stearic acid, arachic acid, and behenic acid, or the corresponding branched chain fatty acids or unsaturated fatty acids such as oleic acid, or mixtures of any of these materials.

In certain embodiments, suitable synthetic ester components include the esters of trimethylol propane, trimethylol butane, trimethylol ethane, pentaerythritol and/or dipentaerythritol with one or more monocarboxylic acids containing from 5 to 10 carbon atoms. These esters are widely available commercially, for example, the Mobil P-41 and P-51 esters of ExxonMobil Chemical Company.

In other embodiments, useful esters may be those derived from renewable material such as coconut, palm, rapeseed, soy, sunflower and the like. These esters may be monoesters, di-esters, polyol esters, complex esters, or mixtures thereof. These esters are widely available commercially, for example, the Mobil P-51 ester of ExxonMobil Chemical Company.

The lubricating oils of this disclosure may be useful as passenger vehicle engine oil (PVEO) products or commercial vehicle engine oil (CVEO) products.

The polymeric (e.g., oligomeric) antioxidant compositions may be formulated together with one to three further additives selected from the group consisting of further antioxidants, metal passivators, rust inhibitors, corrosion inhibitors, viscosity index improvers, extreme pressure agents, pour point depressants, solid lubricants, dispersants, detergents, antifoams, color stabilizers, demulsifiers, friction modifiers and antiwear additives.

Examples of antioxidants may include 1) alkylated monophenols, for example 2,6-di-tert-butyl-4-methylphenol, 2-butyl-4,6-dimethylphenol, 2,6-di-tert-butyl-4-ethylphenol, 2,6-di-tert-butyl-4-n-butylphenol, 2,6-di-tert-butyl-4-iso-butylphenol, 2,6-di-cyclopentyl-4-methylphenol, 2-(a-methyl-cyclohexyl)-4,6-dimethylphenol, 2,6-di-octadecyl-4-methylphenol, 2,4,6-tri-cyclohexylphenol, 2,6-di-tert-butyl-4-methoxymethylphenol, linear or side chain-branched nonylphenols, for example 2,6-di-nonyl-4-methylphenol, 2,4-dimethyl-6-(1′-methyl-undec-1′-yl)phenol, 2,4-dimethyl-6-(1′-methylheptadec-1′-yl)phenol, 2,4-dimethyl-6-(1′-methyltridec-1′-yl)phenol or mixtures thereof; 2) alkylthiomethylphenols, for example 2,4-di-octylthiomethyl-6-tert-butylphenol, 2,4-di-octylthiomethyl-6-methylphenol, 2,4-di-octylthiomethyl-6-ethylphenol or 2,6-di-dodecylthiomethyl-4-nonylphenol; 3) hydroquinones and alkylated hydroquinones, for example 2,6-di-tert-butyl-4-methoxyphenol, 2,5-di-tert-butylhydroquinone, 2,5-di-tert-amylhydroquinone, 2,6-diphenyl-4-octadecyloxyphenol, 2,6-di-tert-butyl-hydroquinone, 2,5-di-tert-butyl-4-hydroxyanisole, 3,5-di-tert-butyl-4-hydroxyanisole, 3,5-di-tert-butyl-4-hydroxyphenyl stearate or bis(3,5-di-tert-butyl-4-hydroxyphenyl) adipate; 4) tocopherols, for example α-, β-, γ- or ε-tocopherol or mixtures thereof (vitamin E); 5) hydroxylated thiodiphenyl ethers, for example 2,2′-thiobis(6-tert-butyl-4-methylphenol), 2,2′-thiobis(4-octylphenol), 4,4′-thiobis(6-tert-butyl-3-methylphenol), 4,4′-thiobis-(6-tert-butyl-2-methylphenol), 4,4′-thiobis(3,6-di-sec-amylphenol) or 4,4′-bis(2,6-dimethyl-4-hydroxyphenyl) disulfide; 6) alkylidenebisphenols, for example 2,2′-methylenebis(6-tert-butyl-4-methylphenol), 2,2′-methylenebis(6-tert-butyl-4-ethylphenol), 2,2′-methylenebis(4-methyl-6-(alpha-methylcyclohexyl)-phenol), 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butylphenol), 2,2′-ethylidenebis(6-tert-butyl-4-isobutylphenol), 2,2′-methylenebis(6-(alpha-methylbenzyl)-4-nonylphenol), 2,2′-methylene-bis(6-(alpha,alpha-dimethylbenzyl)-4-nonylphenol), 4,4′-methylenebis(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methylphenyl)-3-n-dodecylmercaptobutane, ethylene glycol bis(3,3-bis(3′-tert-butyl-4′-hydroxyphenyl)butyrate), bis(3-tert-butyl-4-hydroxy-5-methylphenyl)dicyclo-pentadiene, bis(2-(3′-tert-butyl-2′-hydroxy-5′-methylbenzyl)-6-tert-butyl-4-methylphenyl)terephthalate, 1,1-bis(3,5-dimethyl-2-hydroxyphenyl)butane, 2,2-bis(3,5-di-tert-butyl-4-hydroxyphenyl)propane, 2,2-bis(5-tert-butyl-4-hydroxy-2-methylphenyl)-4-n-dodecylmercaptobutane or 1,1,5,5-tetra(5-tert-butyl-4-hydroxy-2-methylphenyl)-pentane; 7) O- N- and S-benzyl compounds, for example 3,5,3′,5′-tetra-tert-butyl-4,4′-dihydroxydibenzyl ether, octadecyl 4-hydroxy-3,5-dimethylbenzylmercaptoacetate, tridecyl 4-hydroxy-3,5-di-tert-butylbenzylmercaptoacetate, tris(3,5-di-tert-butyl)amine, bis(4-tert-butyl-3-hydroxy-2,6-dimethylbenzyl)dithioterephthalate, bis(3,5-di-tert-butyl-4-hydroxybenzyl) sulfide or isooctyl 3,5-di-tert-butyl-4-hydroxy-benzylmercaptoacetate; 8) hydroxybenzylated malonates, for example-dioctadecyl 2,2-bis(3,5-di-tert-butyl-2-hydroxybenzyl)malonate, dioctadecyl 2-(3-tert-butyl-4-hydroxy-5-methylbenzyl)-malonate, di-dodecyl mercaptoethyl-2,2-bis(3,5-di-tert-butyl-4-hydroxybenzyl)-malonate or di(4-(1,1,3,3-tetramethylbutyl)phenyl)2,2-bis(3,5-di-tert-butyl-4-hydroxybenzyl)malonate; 9) aromatic hydroxybenzyl compounds, for example 1,3,5-tris(3,5-di-tert-butyl-4-hydroxybenzyl)-2,4,6-trimethylbenzene, 1,4-bis(3,5-di-tert-butyl-4-hydroxybenzyl)-2,3,5,6-tetramethylbenzene or 2,4,6-tris(3,5-di-tert-butyl-4-hydroxybenzyl)phenol; 10) triazine compounds, for example 2,4-bisoctylmercapto-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris(3,5-di-tert-butyl-4-hydroxyphenoxy)-1,2,3-triazine, 1,3,5-tris(3,5-di-tert-butyl-4-hydroxybenzyl)-isocyanurate, 1,3,5-tris(4-tert-butyl-3-hydroxy-2,6-dimethylbenzyl) isocyanurate, 2,4,6-tris(3,5-di-tert-butyl-4-hydroxyphenylethyl)-1,3,5-triazine, 1,3,5-tris(3,5-di-tert-butyl-4-hydroxyphenylpropionyl)hexahydro-1,3,5-triazine or 1,3,5-tris(3,5-dicyclohexyl-4-hydroxybenzyl)-isocyanurate; 11) benzylphosphonates, for example dimethyl 2,5-di-tert-butyl-4-hydroxybenzyl-phosphonate, diethyl 3,5-di-tert-butyl-4-hydroxybenzylphosphonate, dioctadecyl 3,5-di-tert-butyl-4-hydroxybenzylphosphonate, dioctadecyl 5-tert-butyl-4-hydroxy-3-methylbenzylphosphonate or the calcium salt of the monoethyl ester of 3,5-di-tert-butyl-4-hydroxybenzylphosphonic acid; 12) acylaminophenols, for example 4-hydroxylauranilide, 4-hydroxystearanilide or octyl N-(3,5-di-tert-butyl-4-hydroxyphenyl)carbamate; 13) esters of β-(3,5-di-tert-butyl-4-hydroxyphenyl)propionic acid, β-(5-tert-butyl-4-hydroxy-3-methylphenyl)propionic acid, β-(3,5-dicyclohexyl-4-hydroxyphenyl)-propionic acid, 3,5-di-tert-butyl-4-hydroxyphenylacetic acid or β-(5-tert-butyl-4-hydroxyphenyl)-3-thiabutyric acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl) isocyanurate, N,N′-bis(hydroxyethyl)oxalamide, 3-thiaundecanol, 3-thiapentadecanol, trimethyl-hexanediol, trimethylolpropane, 4-hydroxymethyl-1-phospha-2,6,7-trioxabicyclo(2.2.2)octane, glycerol or transesterification products based on natural triglycerides of, for example, coconut oil, rape seed oil, sunflower oil or colza oil; 14) amides of β-(3,5-di-tert-butyl-4-hydroxyphenyl)propionic acid, e.g. N,N′-bis(3,5-di-tert-butyl-4-hydroxyphenylpropionyl)hexamethylenediamine, N,N′-bis(3,5-di-tert-butyl-4-hydroxyphenylpropionyl)trimethylenediamine or N,N′-bis(3,5-di-tert-butyl-4-hydroxyphenylpropionyl)hydrazine; 15) ascorbic acid (vitamin C); 16) amine-type antioxidants, for example N,N′-diisopropyl-p-phenylenediamine, N,N′-di-sec-butyl-p-phenylenediamine, N,N′-bis(1,4-dimethylpentyl)-p-phenylenediamine, N,N′-bis(1-ethyl-3-methyl-pentyl)-p-phenylenediamine, N,N′-bis(1-methyl-heptyl)-p-phenylendiamine, N,N′-dicyclohexyl-p-phenylenediamine, N,N′-diphenyl-p-phenylenediamine, N,N′-di-(naphth-2-yl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-toluenesulfonamido)diphenylamine, N,N′-dimethyl-N,N′-di-sec-butyl-p-phenylenediamine, diphenylamine, N-allyldiphenylamine, 4-isopropoxy-diphenylamine, N-phenyl-1-naphthylamine, N-(4-tert-octylphenyl)-1-naphthylamine, N-phenyl-2-naphthylamine, octylated diphenylamine, e.g. p,p′-di-tert-octyidiphenylamine, 4-n-butylaminophenol, 4-butyrylamino-phenol, 4-nonanoylamino-phenol, 4-dodecanoylaminophenol, 4-octadecanoylamino-phenol, di-(4-methoxyphenyl)-amine, 2,6-di-tert-butyl-4-dimethylamino-methyl-phenol, 2,4′-diamino-diphenylmethane, 4,4′-diamino-diphenylmethane, N,N,N′,N′-tetramethyl-4,4′-diamino-diphenylmethane, 1,2-di-((2-methyl-phenyl)-amino)-ethane, 1,2-di-(phenylamino)propane, (o-tolyl)biguanide, di(4-(1′,3′-dimethyl-butyl)-phenyl)amine, tert-octylated N-phenyl-1-naphthylamine, a mixture of mono- and dialkylated tert-butyl/tert-octyidiphenylamines, a mixture of mono- and dialkylated nonyldiphenylamines, a mixture of mono- and dialkylated dodecyldiphenylamines, a mixture of mono- and dialkylated isopropyl/isohexyldiphenylamines, mixtures of mono- and dialkylated tert-butyidiphenylamines, 2,3-dihydro-3,3-dimethyl-4H-1,4-benzothiazine, phenothiazine, a mixture of mono- and dialkylated tert-butyl/tert-octyl-phenothiazines, a mixture of mono- and dialkylated tert-octyl-phenothiazines, N-allylphenothiazine, N,N,N′,N′-tetraphenyl-1,4-diaminobut-2-ene, N,N-bis-(2,2,6,6-tetramethylpiperidin-4-yl)hexamethylenediamine, bis-(2,2,6,6-tetramethylpiperidin-4-yl) sebacate, 2,2,6,6-tetramethylpiperidin-4-one or 2,2,6,6-tetramethylpiperidin-4-ol; and 17) aliphatic or aromatic phosphites, esters of thiodipropionic acid or of thiodiacetic acid, or salts of dithiocarbamic or dithiophosphoric acid, 2,2,12,12-tetramethyl-5,9-dihydroxy-3,7,1-trithiatridecane or 2,2,15,15-tetramethyl-5,12-dihydroxy-3,7,10,14-tetrathiahexadecane.

Examples of metal passivators, for example for copper, include 1) benzotriazoles and their derivatives, for example 4- or 5-alkylbenzotriazoles (e.g. tolutriazole) and derivatives thereof, 4,5,6,7-tetrahydrobenzotriazole, 5,5′-methylenebisbenzotriazole; Mannich bases of benzotriazole or tolutriazole, such as 1-(di(2-ethylhexyl)aminomethyl)tolutriazole and 1-(di(2-ethylhexyl)aminomethyl)-benzotriazole; alkoxyalkylbenzotriazoles, such as 1-(nonyloxymethyl)-benzotriazole, 1-(1-butoxyethyl)-benzotriazole and 1-(1-cyclohexyloxybutyl)-tolutriazole; 2) 1,2,4-triazoles and derivatives thereof, for example 3-alkyl(or aryl)-1,2,4-triazoles, Mannich bases of 1,2,4-triazoles such as 1-(di(2-ethylhexyl)aminomethyl)-1,2,4-triazole; alkoxyalkyl-1,2,4-triazoles such as 1-(1-butoxyethyl)-1,2,4-triazole; acylated 3-amino-1,2,4-triazoles; 3) imidazole derivatives, for example 4,4′-methylenebis(2-undecyl-5-methyl-imidazole), bis((N-methyl)imidazol-2-yl)carbinol octyl ether; 4) sulfur-containing heterocyclic compounds, for example 2-mercaptobenzothiazole, 2,5-dimercapto-1,3,4-thiadiazole, 2,5-dimercaptobenzothiadiazole and derivatives thereof; 3,5-bis(di(2-ethylhexyl)aminomethyl)-1,3,4-thiadiazolin-2-one; and 5) amino compounds, for example salicylidenepropylenediamine, salicylaminoguanidine and salts thereof.

Examples of rust inhibitors include 1) organic acids, their esters, metal salts, amine salts and anhydrides, for example alkyl- and alkenylsuccinic acids and the partial esters thereof with alcohols, diols or hydroxycarboxylic acids, partial amides of alkyl- and alkenylsuccinic acids, 4-nonylphenoxyacetic acid, alkoxy- and alkoxyethoxycarboxylic acids, such as dodecyloxyacetic acid, dodecyloxy(ethoxy)acetic acid and the amine salts thereof, and also N-oleoylsarcosine, sorbitan monooleate, lead naphthenate, alkenylsuccinic anhydrides, for example dodecenylsuccinic anhydride, 2-(2-carboxyethyl)-1-dodecyl-3-methylglycerine and its salts, especially sodium and triethanolamine salts; 2) nitrogen-containing compounds, for example primary, secondary or tertiary aliphatic or cycloaliphatic amines and amine salts of organic and inorganic acids, for example oil-soluble alkylammonium carboxylates, and also 1-(N,N-bis(2-hydroxyethyl)amino)-3-(4-nonylphenoxy)propan-2-ol; ii) heterocyclic compounds, for example: substituted imidazolines and oxazolines, 2-heptadecenyl-1-(2-hydroxyethyl)-imidazoline; 3) phosphorus-containing compounds, for example Amine salts of phosphoric acid partial esters or phosphonic acid partial esters, zinc dialkyldithiophosphates; 4) sulfur-containing compounds, for example: barium dinonylnaphthalene-sulfonates, calcium petroleumsulfonates, alkylthio-substituted aliphatic carboxylic acids, esters of aliphatic 2-sulfocarboxylic acids and salts thereof; and 5) glycerine derivatives, for example: glycerine monooleate, 1-(alkylphenoxy)-3-(2-hydroxyethyl)glycerines, 1-(alkylphenoxy)-3-(2,3-dihydroxypropyl)glycerines, 2-carboxyalkyl-1,3-dialkylglycerines.

Viscosity index improvers useful in the present disclosure include any of the polymers which impact enhanced viscosity properties to the finished oil and may generally be hydrocarbon-based polymers having a weight average molecular weight, Mw, in the range of between about 2,000 to 1,000,000, for instance about 50,000 to 200,000. Viscosity index improver polymers typically include olefin copolymers, for example, ethylene-propylene copolymers, ethylene-(iso)-butylene copolymers, propylene-(iso)-butylene copolymers, ethylene-polyalphaolefin copolymers, polymethacrylates; styrene-diene block copolymers, for example, styrene-isoprene copolymers, and star copolymers; polyacrylates, polymethacrylates, vinylpyrrolidone/methacrylate copolymers, polyvinylpyrrolidones, polybutenes, styrene/acrylate copolymers, and polyethers. Viscosity index improvers may be monofunctional or multifunctional, such as those bearing substituents that provide a secondary lubricant performance feature such as dispersancy, pour point depression, etc.

Examples of pour point depressants include polymethacrylate, alkylated naphthalene derivatives.

Examples of dispersants/surfactants include polybutenylsuccinamides or -imides, polybutenylphosphonic acid derivatives, and basic magnesium, calcium and barium sulfonates, phenolates and salicylates.

Examples of antifoams include silicone oils and polymethocrylen.

Demulsifiers may for example be selected from polyetherpolyols and dinonylnaphthalenesulfonates.

Friction modifiers may for example be selected from fatty acids and their derivatives (i.e. natural esters of fatty acids such as glycerol monooleate), amides, imides and amines (i.e. oleylamine), sulfur containing organomolybdenum dithiocarbamates, sulfur-phosphorus containing organomolybdenum dithiophosphates, sulfur-nitrogen containing organomolybdenum compounds based on dispersants, molybdenum carboxylate salts, molybdenum-amine complexes, molybdenum amine/alcohol/amid complexes and molybdenum cluster compounds, Teflon™ and molybdenum disulfide.

Examples of antiwear additives include sulfur- and/or phosphorus- and/or halogen-containing compounds, such as sulfurized olefins and vegetable oils, zinc dialkyldithiophosphates, tritolyl phosphate, tricresyl phosphate, chlorinated paraffins, alkyl and aryl di- and trisulfides, amine salts of mono- and dialkyl phosphates, amine salts of methylphosphonic acid, diethanolaminomethyltolyltriazole, di-(2-ethylhexyl)-aminomethyltolyltriazole, derivatives of 2,5-dimercapto-1,3,4-thiadiazole, ethyl(bisisopropyloxyphosphinothioyl)thiopropionate, triphenyl thiophosphate (triphenyl phosphorothioate), tris(alkylphenyl) phosphorothioates and mixtures thereof (for example tris(isononylphenyl) phosphorothioate), diphenylmonononylphenyl phosphorothioate, isobutylphenyl diphenyl phosphorothioate, the dodecylamine salt of 3-hydroxy-1,3-thiaphosphetan 3-oxide, trithiophosphoric acid 5,5,5-tris-isooctyl 2-acetate, derivatives of 2-mercaptobenzothiazole, such as 1-N,N-bis(2-ethylhexyl)aminomethyl-2-mercapto-1H-1,3-benzothiazole, and ethoxycarbonyl 5-octyldithiocarbamate; dihydrocarbyl dithiophosphate metal salts where the metal is aluminum, lead, tin manganese, cobalt, nickel, zinc or copper, but most often zinc. The zinc salt (zinc dialkyl dithiophosphate) is represented as

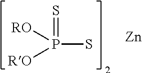

where R and R′ are independently C₁-C₂₀ alkyl, C₃-C₂₀ alkenyl, C₅-C₁₂ cycloalkyl, C₇-C₁₃ aralkyl or C₆-C₁₀ aryl, for example R and R′ are independently C₁-C₁₂ alkyl.

Antiwear additives are described in U.S. Pat. Nos. 4,584,021; 5,798,321; 5,750,478; 5,801,130; 4,191,666; 4,720,288; 4,025,288; 4,025,583 and WO 095/20592; amines for example polyalkylene amines such as ethylene diamine, diethylene triamine, triethylene tetraamine, tetraethylene pentamine, pentaethylene hexamine, nonaethylene decamine and aryl amines as described in U.S. Pat. No. 4,267,063; salts of amine phosphates comprising specialty amines and mixed mono- and di-acid phosphates; mono- and di-acid phosphate amines of formulae:

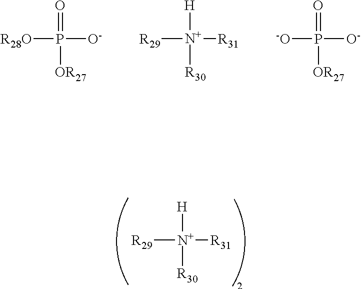

wherein R₂₇ is hydrogen, C₁-C₂₅ linear or branched chain alkyl which is unsubstituted or substituted by one or more C₁-C₆alkoxy groups, a saturated acyclic or alicyclic group, or aryl; R₂₈ is C₁-C₂₅ linear or branched chain alkyl which is unsubstituted or substituted by one or more C₁-C₆alkoxy groups, a saturated acyclic or alicyclic group, or aryl; R₂₉ is hydrogen, C₁-C₂₅ linear or branched chain alkyl, a saturated or unsaturated acyclic or alicyclic group, or aryl; and are hydrogen or C₁-C₁₂ linear or branched chain alkyl; and R₃₀ and R₃, are, each independently of the other, C₁-C₂₅ linear or branched chain alkyl, a saturated or unsaturated acyclic or alicyclic group, or aryl. Preferably, R₂₇ and R₂₈ are linear or branched C₁-C₁₂ alkyl; and R₂₉, R₃₀ and R₃, are linear or branched C₁-C₁₈ alkyl; a compound of formula (R₃₃O)ₓ—P(O)—(OH)_{y}.(HN(R₃₄)₂)_{y}, wherein R₃₃ is n-hexyl, R₃₄ is C₁₁-C₁₄ branched alkyl, and when x=1 then y=2; when x=2 then y=1; for example a mixture of amine phosphates, CAS #80939-62-4; other antiwear additives are compounds of formula

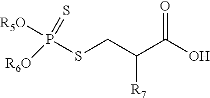

in which R₅ and R₆ independently of one another are C₃-C₁₈ alkyl, C₅-C₁₂ cycloalkyl, C₅-C₆ cycloalkylmethyl, C₉-C₁₀ bicycloalkylmethyl, C₉-C₁₀ tricycloalkylmethyl, phenyl or C₇-C₂₄ butylhydroquinone, alkylphenyl or together are (CH₃)₂C(CH₂)₂, R₇ is hydrogen or methyl. For example, a dialkyl dithiophosphate ester, CAS #268567-32-4.

The present lubricating oil compositions can contain, in addition to the antioxidant additives, other additives including lead scavengers such as haloalkanes (e.g., ethylene dichloride and ethylene dibromide), deposit preventers or modifiers such as triaryl phosphates, dyes, cetane improvers, antioxidants such as 2,6-di-tert-butyl-4-methylphenol, rust inhibitors such as alkylated succinic acids and anhydrides, bacteriostatic agents, gum inhibitors, metal deactivators, demulsifiers, upper cylinder lubricants and anti-icing agents.

The present antioxidant compositions can be introduced into the lubricating oil in manners known per se. The compounds may be readily soluble in oils. They may be added directly to the lubricating oil or they can be diluted with a substantially inert, normally liquid organic diluent such as naphtha, benzene, toluene, xylene or a normally liquid oil or fuel to form an additive concentrate or masterbatch. Antioxidant concentrates may include base stocks, such as ester base stocks, as a diluent. In certain embodiments, antioxidant concentrates include solvents such as glymes, such as monomethyl tetraglyme. These concentrates generally contain from any of about 10%, about 15%, about 20%, about 25%, about 30%, about 35%, about 40%, about 45% or about 50% to any of about 55%, about 60%, about 65%, about 70%, about 75%, about 80%, about 85%, about 90% or about 95% by weight antioxidant polymer (e.g., oligomer) composition and may contain one to three other additional additives. The present antioxidant compositions may be introduced as part of a liquid blend or a solid.

The antioxidant polymer (e.g., oligomer) compositions of this disclosure may be in the form of the liquid blend by dilution with from one to three liquid additives disclosed herein, for instance one to three liquid dispersants, detergents, antiwear additives, corrosion inhibitors or antioxidants mentioned herein. Liquid antioxidants may include certain aminic and phenolic antioxidants. Further aminic and phenolic antioxidants may include one or more of N,N-di-(p-tert-butylphenyl)amine, N,N-di-(p-tert-octylphenyl)amine, N-(p-tert-butylphenyl)-N-phenylamine, N-(p-tert-octylphenyl)-N-phenylamine and N-(p-tert-butylphenyl)-N-(p-tert-octylphenyl)amine, bis-nonylphenyldiphenylamine, N-(tert-C₁-C₂₀alkylphenyl)-1-naphthylamine and 3,5-di-tert-butyl-4-hydroxyhydrocinnamic acid octyl ester.

Certain embodiments are directed to a liquid blend comprising the antioxidant polymer (e.g., oligomer) composition and one to three components selected from the group consisting of solvents, base oils, further antioxidants, metal passivators, rust inhibitors, corrosion inhibitors, viscosity index improvers, extreme pressure agents, pour point depressants, dispersants, detergents, antifoams, color stabilizers, demulsifiers, friction modifiers and antiwear additives. The liquid blend can then be utilized to prepare formulated lubricant compositions and the term “liquid blend” does not encompass a formulated lubricant composition. Liquid means liquid at 25° C. These liquid blends may be considered antioxidant polymer (e.g., oligomer) composition concentrates wherein the weight levels of the polymer (e.g., oligomer) composition are as above. Base oils include those of API (American Petroleum Institute) groups I, II, III, IV, V and VI.

In other embodiments, disclosed is a method of preparing a liquid blend, the method comprising mixing the antioxidant polymer (e.g., oligomer) composition with one to three components selected from the group consisting of solvents, base oils, further antioxidants, metal passivators, rust inhibitors, corrosion inhibitors, viscosity index improvers, extreme pressure agents, pour point depressants, dispersants, detergents, antifoams, color stabilizers, demulsifiers, friction modifiers and antiwear additives.

The effective stabilizing amount of polymer (e.g., oligomer) to be added to a base oil is that to provide the desired good balance of deposits performance, good color and viscosity control. For instance, the effective amount of polymer (e.g., oligomer) is from about 0.01 wt %, about 0.05, about 0.1, about 0.3, about 0.5, about 0.7, about 1.0, about 1.5, about 2.0, about 2.5, about 3.0, about 3.5, about 4.0, about 4.5, about 5.0, about 5.5, about 6.0, about 6.5, about 7.0, about 7.5, about 8.0, about 8.5 or about 9.0 wt % to about 10, about 11, about 12, about 13, about 14, about 15, about 16, about 17, about 18, about 19 or about 20 wt % of the polymer (e.g., oligomer), based on the total weight of the lubricating oil composition.

The articles “a” and “an” herein refer to one or to more than one (e.g. at least one) of the grammatical object. Any ranges cited herein are inclusive. The term “about” used throughout is used to describe and account for small fluctuations. For instance, “about” may mean the numeric value may be modified by ±5%, ±4%, ±3%, ±2%, ±1%, ±0.5%, ±0.4%, ±0.3%, ±0.2%, ±0.1% or ±0.05%. All numeric values are modified by the term “about” whether or not explicitly indicated. Numeric values modified by the term “about” include the specific identified value. For example “about 5.0” includes 5.0.

U.S. patents, U.S. patent applications and published U.S. patent applications discussed herein are hereby incorporated by reference.

Unless otherwise indicated, all parts and percentages are by weight. Weight percent (wt %), if not otherwise indicated, is based on an entire composition free of any volatiles.

### EXAMPLE 1

### Polymer Preparation

An antioxidant diphenyl amine monomer mixture containing N,N-diphenylamine, N,N-di-(p-tert-butylphenyl)amine, N,N-di-(p-tert-octylphenyl)amine, N-(p-tert-butylphenyl)-N-phenylamine, N-(p-tert-octylphenyl)-N-phenylamine and N-(p-tert-butylphenyl)-N-(p-tert-octylphenyl)amine is charged together with n-decane to a 3 L glass reactor connected to a Dean-Stark head with a reflux condenser. The mixture is heated to 135° C. and t-butylperoxide is added dropwise with stirring. The temperature is maintained at 135° C. to 140° C. with stirring and t-butanol is distilled off. Samples are removed and tested for viscosity. Upon reaching a desired viscosity, unreacted peroxide is removed under reduced pressure, then the mixture is heated under reduced pressure to remove remaining volatiles. The diphenyl amine monomer mixture is CAS number 68411-46-1; N-phenyl-benzenamine reaction products with 2,4,4-trimethylpentene.

The monomer mixture exhibits a viscosity of 9.1 cSt (monomer). Polymers or oligomers are prepared having viscosities of 21 cSt (inventive sample 1), 81 cSt (inventive sample 2) and 100 cSt (inventive sample 3). Viscosity is kinematic viscosity at 100° C. determined according to ASTM D445.

The viscosity and Mn of the samples can be controlled by, e.g., the length of the reaction or the feed of the peroxide.

### EXAMPLE 2

### Bench Testing

Fully formulated oils are prepared containing 81.8% base stock, 16.2% additives and 2%, each by weight, of the samples of Example 1. All formulated oils exhibit a viscosity at 40° C. of from 52-53 cSt according to ASTM D445. The samples are tested for total deposits according to TEOST MHT 4 test (ASTM D7097), a bench test used to evaluate oil performance relative to forming moderately high temperature piston deposits when subjected to high power and temperature operating conditions. The samples are also tested for total deposits according to TEOST 33C (ASTM D6335), a test that simulates the effect of engine operating conditions on the oxidation and deposit-forming tendencies of engine oils, especially in the high temperature turbocharger area. Total deposits results (mg) are below.

| sample | TEOST MHT 4 | TEOST 33C |
|---|---|---|
| monomer | 55 | 36 |
| inventive 1 | 45 | 36 |
| inventive 2 | 41 | 33 |
| inventive 3 | 35 | 31 |

Inventive samples are superior regarding deposits formation.

### EXAMPLE 3

### Engine Testing

The formulated oils containing inventive sample 3 and the monomer mixture are tested according to a modified Sequence IIIH engine test. The additives are each added to an engine oil at 2 wt %. The Sequence IIIH Test (ASTM D8111) is a fired-engine, dynamometer lubricant test for evaluating automotive engine oils for certain high-temperature performance characteristics, including oil thickening, varnish deposition and oil consumption. Results are below.

| | monomer | inventive 3 |
|---|---|---|
| EOT % viscosity increase | 432% | 68% |
| weighted piston deposit merits | 4.72 | 5.06 |
| average piston varnish merits | 9.61 | 9.87 |

EOT % viscosity increase is “end of test” viscosity increase. The inventive 3 sample provides for outstanding viscosity performance while maintaining improved deposits performance. Higher “merits” is better.

### EXAMPLE 4

### Color

The formulated oils containing inventive sample 3 and the monomer mixture exhibit an ASTM D1500 color rating of 4.0 and 3.5, respectively.

### EXAMPLE 5

It is demonstrated that m/z ions in the isolated polymers and oligomers show a correlation to increased performance in a VIT test.

The table below shows that the m/z ion counts at 838, 984 and 911 Daltons are significantly higher than the #4 residue which has a lower VIT result. The higher the VIT value, the better the antioxidant

| Sample | VIT (h to pvisc 150) | 838 | 894 | 911 |
|---|---|---|---|---|
| Reference | 470 | 0 | 0 | 0 |
| Sample 1 | 830 | 296 | 225 | 65 |
| Sample 2 | 797 | 386 | 179 | 65 |
| Sample 3 | 533 | 49 | 65 | 8 |

FIG. 1 shows a trend that VIT performance is better when there is a greater amount of dimers and trimers as compared to the amount of higher polymers (4+) in conjunction with the LC/MS data that yields the 838 and 894 (which corresponds to 837 and 893 Daltons)

### EXAMPLE 6

A polymeric composition of the present disclosure is included as a component in a grease formulation as shown below.

| | Formulation Details (wt %) | | |
|---|---|---|---|
| Base Stocks | 71.5-73% | 71.5-73% | 71.5-73% |
| Thickener | 7-8.5 | 7-8.5 | 7-8.5 |
| Additives | 13.37 | 13.37 | 13.37 |
| (Standard) IRGANOX L57 | 1.00 | 2.00 | 0.00 |
| Inventive 3 | 0.00 | 0.00 | 1.00 |
| Total | 100 | 100 | 100 |
| | Testing Results | | |
| ASTM D445 - Kinematic Viscosity | 220.0 | 220.0 | 220.0 |
| at 40° C. (cSt) | | | |
| ASTM D217 - Penetration, | 287.0 | 287.0 | 294.0 |
| Worked (0.1 mm) | | | |
| ASTM D5483 PDSC of Greases | 23 | N/A | 17.3 |
| (Isothermal at 210 C.) | | | |
| ASTM D942 - Pressure Vessel | 1.1 | N/A | 2.4 |
| Oxidation Test @ 100 hrs | | | |
| (psi drop) | | | |
| ASTM D942 - Pressure Vessel | 8 | N/A | 10.4 |
| Oxidation Test @ 100 hrs | | | |
| (psi drop) | | | |
| DIN 51821 FAG FE9 FE9 | 84.0 | | 135.0 |
| A/1500/6000 @ 140 C. (B50, hours) | | | |

All of the formulations in the above Table are Lithium complex (thickner type) greases, with ISO Viscosity grades of 220 and an NLGI consistency grade of 2. Common grease thickener types are simple lithium soap , lithium complex soap, polyurea, calcium sulfonate, aluminum soap, calcium soap, mixed aluminum/calcium, clay and polymer thickened. Greases contain, e.g., 70-80% basestock, 0.1-20% thickener, and 0-20% additives. The data demonstrates that the inventive example treated at 1% has the same oxidative performance as the commercial example treated at 1% in grease bench oxidation tests (ASTM D5483 and D942). However, when the same greases were tested in the DIN 51821 FAG FE9 test (rig test—high temperature bearing performance of a grease) the grease with the inventive example demonstrated superior performance compare to the grease that contained 1% commercial example and the grease that contained 2% of the commercial example. This is unexpected given the equivalent performance in the bench oxidation testing. According to the above data, the inventive polymer composition can be utilized in the preparation of a grease to improve high temperature bearing performance.

### EXAMPLE 7

A polymeric composition of the present invention is included as a component in an industrial oil formulation as shown below.

| Base Stocks | 97.94 | 97.94 | 97.94 | 97.94 | 97.94 | 97.94 |
|---|---|---|---|---|---|---|
| Additives | 13.37 | 13.37 | 13.37 | 13.37 | 13.37 | 13.37 |
| (Standard) | 1.00 | 0.00 | 0.00 | 0.70 | 0.00 | 0.00 |
| IRGANOX | | | | | | |
| L57 | | | | | | |
| Inventive 3 | 0.00 | 1.00 | 0.00 | 0.00 | 0.00 | 0.00 |
| Inventive 7 | 0.00 | 0.00 | 1.00 | 0.00 | 0.70 | 0.00 |
| Inventive 8 | 0.00 | 0.00 | 0.00 | 0.00 | 0.00 | 0.70 |
| Total | 100 | 100 | 100 | 100 | 100 | 100 |
| | Testing Results | | | | | |
| ASTM D445 - | 30.4 | 30.8 | 31.1 | 30.6 | 30.9 | 31 |
| Kinematic | | | | | | |
| Viscosity at | | | | | | |
| 40° C. (cSt) | | | | | | |
| ASTM D2272 - | 1974.0 | 2119.0 | 2036 | 2207 | 2611 | 2027 |
| RPVOT at | | | | | | |
| 150 C. (min) | | | | | | |
| High Pressure | 222.2 | 193.1 | 236.58 | 47.3 | 94.03 | 20 |
| Differential | | | | | | |
| Scanning Calo- | | | | | | |
| rimetry (min) | | | | | | |

### EXAMPLE 8

A polymeric composition of the present invention is included as a component in a passenger vehicle lubricant formulation as shown below.

| | Formulation Details (wt %) | | | | | | |
|---|---|---|---|---|---|---|---|
| Base Stocks | 81.76 | 81.76 | 81.76 | 81.76 | 81.76 | 81.76 | 81.76 |
| Additives | 16.24 | 16.24 | 16.24 | 16.24 | 16.24 | 16.24 | 16.24 |
| (Standard) IRGANOX L57 | 2.00 | 0.00 | 0.00 | 0.00 | 0.00 | 0.00 | 0.00 |
| Inventive 2 | 0.00 | 2.00 | 0.00 | 0.00 | 0.00 | 0.00 | 0.00 |
| Inventive 1 | 0.00 | 0.00 | 2.00 | 0.00 | 0.00 | 0.00 | 0.00 |
| Inventive 3 | 0.00 | 0.00 | 0.00 | 2.00 | 0.00 | 0.00 | 0.00 |
| Inventive 7 | 0.00 | 0.00 | 0.00 | 0.00 | 2.00 | 0.00 | 0.00 |
| Inventive 8 | 0.00 | 0.00 | 0.00 | 0.00 | 0.00 | 2.00 | 0.00 |
| Inventive 9 | 0.00 | 0.00 | 0.00 | 0.00 | 0.00 | 0.00 | 2.00 |
| Total | 100 | 100 | 100 | 100 | 100 | 100 | 100 |
| | Testing Results | | | | | | |
| ASTM D445 - Kinematic | 51.9 | 52.6 | 53.2 | 53.2 | 53.7 | 53.4 | 54.4 |
| Viscosity at 40° C. (cSt) | | | | | | | |
| ASTM D7097 - TEOST MHT4 | 55.0 | 45.2 | 41.0 | 34.8 | — | — | — |
| (Total deposits, mg) | | | | | | | |
| ASTM D6335 - TEOST 33C | 35.8 | 36.2 | 33.0 | 30.8 | — | — | — |
| (Total deposits, mg) | | | | | | | |
| ASTM D1500 - Color | 3.5 | TBD | TBD | 4.0 | 5.5 | 6 | 5 |
| ASTM D8111 - Sequence IIIH, | 432% | — | — | 68% | 114.6 | 240.3 | 172.2 |
| EOT % Viscosity increase | | | | | | | |
| ASTM D8111 - Sequence IIIH, | 4.72 | — | — | 5.06 | 5.15 | 4.27 | 4.87 |
| Weighted Piston Deposit Merits | | | | | | | |
| ASTM D8111 - Sequence IIIH, | 9.61 | — | — | 9.87 | 9.68 | 9.47 | 9.68 |
| Average Piston Varnish Merits | | | | | | | |

### EXAMPLE 9

A polymeric composition of the present invention is included as a component in a commercial vehicle lubricant formulation as shown below.

| | Formulation | |
|---|---|---|
| | Details (wt %) | |
| Base Stocks | 80.38 | 80.38 |
| Additives | 18.22 | 18.22 |
| (Standard) IRGANOX L57 | 1.40 | 0.00 |
| Inventive 3 | 0.00 | 1.40 |
| Total | 100 | 100 |
| | Testing Results | |
| ASTM D445 - Kinematic Viscosity at 40° C. (cSt) | 56.7 | 54.4 |
| ASTM D8048 - Volvo T-13, EOT % Viscosity | 70.6 | 78.9 |
| Increase | | |
| ASTM D8048 - Volvo T-13, IR Peak Increase | 148.0 | 127.0 |

Legend for the above Examples

| Inventive | |
|---|---|
| Antioxidant | |
| Polymer # | |
| Inventive 1 | Lower molecular weight oligomeric material |
| Inventive 2 | Lower molecular weight oligomeric material |
| Inventive 3 | Lower molecular weight oligomeric material |
| Inventive 4 | Oligomers no diluent |
| Inventive 5 | Oligomers no diluent |
| Inventive 6 | Isolated Substance, OECD polymer 75% Mn > 1000 |
| Inventive 7 | 75% Mn > 1000 plus L57 as diluent |
| Inventive 8 | 75% Mn > 1000 plus L57 as diluent |
| Inventive 9 | 75% Mn > 1000 plus L57 as diluent |

1. An antioxidant polymer composition comprising repeat units of diphenylamine monomers of formula I 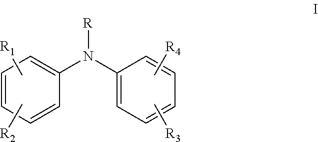
wherein
R is H, C₁-C₁₈ alkyl, C₂-C₁₈ alkenyl, C₂-C₁₈ alkynyl, —C(O)C₁-C₁₈ alkyl, —C(O)aryl and R₁, R₂, R₃ and R₄ are each independently H or a linear or branched C₁-C₁₈ alkyl, C₁-C₁₈ alkoxy, C₁-C₁₈ alkylamino, C₁-C₁₈ dialkylamino, C₁-C₁₈ alkylthio, C₂-C₁₈ alkenyl, C₂-C₁₈ alkynyl or C₇-C₂₁ aralkyl and
wherein
the number average molecular weight (Mn) of the polymer is from about 350 g/mol to about 5000 g/mol.

2. The composition according to claim 1, wherein the Mn is from any one of about 350 g/mol, about 380 g/mol, about 400 g/mol, about 430 g/mol, about 460 g/mol, about 490 g/mol, about 520 g/mol, about 550 g/mol, about 580 g/mol, about 610 g/mol, about 640 g/mol, about 670 g/mol, about 700 g/mol or about 730 g/mol to any one of about 760 g/mol, about 790 g/mol, about 820 g/mol, about 850 g/mol, about 880 g/mol, about 910 g/mol, about 940 g/mol, about 970 g/mol, about 1000 g/mol, about 1030 g/mol, about 1060 g/mol, about 1090 g/mol, about 1120 g/mol, about 1150 g/mol, about 1180 g/mol, about 1210 g/mol, about 1240 g/mol, about 1270 g/mol, about 1300 g/mol, about 1400 g/mol, about 1500 g/mol, about 1600 g/mol, about 1700 g/mol, about 2000 g/mol, about 2100 g/mol, about 2200 g/mol, about 2300 g/mol, about 2400 g/mol, about 2500 g/mol, about 3000 g/mol, about 3500 g/mol, about 4000 g/mol, about 4500 g/mol or about 5000 g/mol.

3. The composition according to claim 1, wherein
R₁, R₂, R₃ and R₄ are each independently H or a linear or branched C₄-C₁₀ alkyl.

4. The composition according to claim 1, wherein
R₁, R₂, R₃ and R₄ are each independently H, tert-butyl or tert-octyl.

5. The composition according to claim 1, further comprising one or more monomers selected from the group consisting of other diphenylamines, phenothiazines, phenoxazines, aminodiphenylamines, methylenedianiline, toluenediamine, aminophenols, alkylphenols, thiophenols, phenylenediamines, quinolines, phenyl pyridinediamines, pyridinepyrimidinediamines and phenylpyrimidinediamines.

6. The composition according to claim 1, comprising from any one of about 10 mol %, about 20 mol %, about 30 mol %, about 40 mol % or about 50 mol % to any one of about 60 mol %, about 70 mol %, about 80 mol %, about 90 mol %, about 95 mol %, about 96 mol %, about 97 mol %, about 98 mol %, about 99 mol % or 100 mol % diphenylamine monomers.

7. The composition according to claim 1, comprising ≤about 70 wt %, ≤about 65 wt %, ≤about 60 wt %, ≤about 55 wt %, ≤about 50 wt %, ≤about 45 wt %, ≤about 40 wt %, ≤about 35 wt %, ≤about 30 wt %, ≤about 25 wt %, ≤about 20 wt %, ≤about 15 wt %, ≤about 10 wt % or ≤about 5 wt % residual monomers of formula I, based on the total weight of the composition.

8. The composition according to claim 1, comprising residual monomer, wherein from any one of about 90 wt %, about 91 wt %, about 92 wt %, about 93 wt %, about 94 wt % or about 95 wt % to any one of about 96 wt %, about 97 wt %, about 98 wt %, about 99 wt % or 100 wt % of the residual monomer is of formula I wherein R₁ and R₄ are independently C₄-C₁₈ alkyl, C₄-C₁₈ alkenyl or C₇-C₂₁ aralkyl, based on the total weight of residual monomer.

9. The composition according to claim 1, having a viscosity of from any one of about 20 cSt, about 30 cSt, about 40 cSt, about 50 cSt, about 60 cSt, about 70 cSt, about 80 cSt, about 81 cSt, about 82 cSt, about 83 cSt, about 84 cSt, about 85 cSt, about 86 cSt, about 87 cSt, about 88 cSt, about 89 cSt, about 90 cSt, about 91 cSt, about 92 cSt, about 93 cSt, about 94 cSt, about 95 cSt, about 96 cSt, about 97 cSt, about 98 cSt or about 99 cSt to any one of about 100 cSt, about 101 cSt, about 102 cSt, about 103 cSt, about 104 cSt, about 105 cSt, about 106 cSt, about 107 cSt, about 108 cSt, about 109 cSt, about 110 cSt, about 111 cSt, about 112 cSt, about 113 cSt, about 114 cSt, about 115 cSt, about 116 cSt, about 117 cSt, about 118 cSt, about 119 cSt, about 120 cSt, about 170 cSt, about 210 cSt, about 260 cSt, about 310 cSt, about 360 cSt, about 410 cSt, about 460 cSt, about 500 cSt, about 530 cSt, about 570 cSt or about 600 cSt.

10. A process for preparing the antioxidant polymer composition according to claim 1, the process comprising subjecting one or more diphenylamine monomers of formula 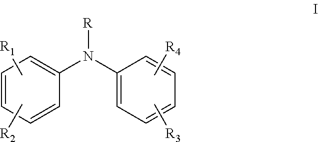
wherein
R is H, C₁-C₁₈ alkyl, C₂-C₁₈ alkenyl, C₂-C₁₈ alkynyl, —C(O)C₁-C₁₈ alkyl, —C(O)aryl and R₁, R₂, R₃ and R₄ are each independently H or a linear or branched C₁-C₁₈ alkyl, C₁-C₁₈ alkoxy, C₁-C₁₈ alkylamino, C₁-C₁₈ dialkylamino, C₁-C₁₈ alkylthio, C₂-C₁₈ alkenyl, C₂-C₁₈ alkynyl or C₇-C₂₁ aralkyl;
to dehydrocondensation conditions.

11. The process according to claim 10, wherein the dehydrocondensation conditions comprise reaction with a free radical precursor.

12. The process according to claim 10, wherein the dehydrocondensation conditions comprise reaction with an organic peroxide.

13. The process according to claim 10, wherein the dehydrocondensation conditions comprise reaction temperatures of from any one of about 40° C., about 60° C., about 80° C., about 100° C., about 120° C., about 140° C. or about 160° C. to any one of about 180° C., about 200° C., about 220° C., about 240° C. or about 250° C.

14. The process according to claim 10, wherein the dehydrocondensation conditions comprise a time period of from any one of about 0.3 hours, about 0.5 hours, about 1 hour, about 2 hours, about 3 hours, about 4 hours, about 5 hours or about 6 hours to any one of about 7 hours, about 8 hours, about 9 hours, about 10 hours, about 11 hours or about 12 hours.

15. The process according to claim 10, wherein the dehydrocondensation conditions are neat.

16. The process according to claim 10, wherein the dehydrocondensation conditions comprise presence of a solvent.

17. The process according to claim 16, wherein the solvent is an organic solvent.

18. The process according to claim 10, comprising purifying a product obtained from the dehydrocondensation conditions.

19. An antioxidant polymer composition prepared according to the process of claim 10.

20. An antioxidant polymer composition comprising repeat units of diphenylamine monomers of formula I 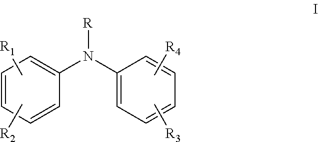
wherein
R is H, C₁-C₁₈ alkyl, C₂-C₁₈ alkenyl, C₂-C₁₈ alkynyl, —C(O)C₁-C₁₈ alkyl, —C(O)aryl and R₁, R₂, R₃ and R₄ are each independently H or a linear or branched C₁-C₁₈ alkyl, C₁-C₁₈ alkoxy, C₁-C₁₈ alkylamino, C₁-C₁₈ dialkylamino, C₁-C₁₈ alkylthio, C₂-C₁₈ alkenyl, C₂-C₁₈ alkynyl or C₇-C₂₁ aralkyl and
wherein the polymer comprises ≤about 70 wt %, ≤about 65 wt %, ≤about 60 wt %, ≤about 55 wt %, ≤about 50 wt %, ≤about 45 wt %, ≤about 40 wt %, ≤about 35 wt %, ≤about 30 wt %, ≤about 25 wt %, ≤about 20 wt %, ≤about 15 wt %, ≤about 10 wt % or ≤about 5 wt % residual monomers of formula I, based on the weight of the composition.

21. The composition according to claim 20 comprising residual monomer, wherein from any one of about 90 wt %, about 91 wt %, about 92 wt %, about 93 wt %, about 94 wt % or about 95 wt % to any one of about 96 wt %, about 97 wt %, about 98 wt %, about 99 wt % or 100 wt % of the residual monomer is of formula I wherein R₁ and R₄ are independently C₄-C₁₈ alkyl, C₄-C₁₈ alkenyl or C₇-C₂₁ aralkyl, based on the total weight of residual monomer.

22. A liquid blend comprising the antioxidant polymer composition according to claim 1 and one to three components selected from the group consisting of solvents, base oils, further antioxidants, metal passivators, rust inhibitors, corrosion inhibitors, viscosity index improvers, extreme pressure agents, pour point depressants, dispersants, detergents, antifoams, color stabilizers, demulsifiers, friction modifiers and antiwear additives.

23. The liquid blend according to claim 22, wherein the one to three components are selected from the group consisting of further antioxidants.

24. The liquid blend according to claim 23, wherein the one to three components are selected from the group consisting of aminic and phenolic antioxidants.

25. The liquid blend according to claim 24, wherein the antioxidants are selected from the group consisting of N,N-di-(p-tert-butylphenyl)amine, N,N-di-(p-tert-octylphenyl)amine, N-(p-tert-butylphenyl)-N-phenylamine, N-(p-tert-octylphenyl)-N-phenylamine and N-(p-tert-butylphenyl)-N-(p-tert-octylphenyl)amine, bis-nonylphenyldiphenylamine, N-(tert-C₁-C₂₀alkylphenyl)-1-naphthylamine and 3,5-di-tert-butyl-4-hydroxyhydrocinnamic acid octyl ester.

26. The liquid blend according to claim 22, wherein the blend comprises a solvent selected from the group consisting of naphtha, benzene, toluene, xylene and glymes.

27. A liquid concentrate comprising the antioxidant polymer composition according to claim 1 and a solvent and/or a base oil, wherein the concentrate comprises from about 50 wt % to about 95 wt %, based on the total weight of the concentrate, of the antioxidant polymer composition.

28. A method of preparing a liquid blend, the method comprising mixing an antioxidant polymer composition according to claim 1 with one to three components selected from the group consisting of solvents, base oils, further antioxidants, metal passivators, rust inhibitors, corrosion inhibitors, viscosity index improvers, extreme pressure agents, pour point depressants, dispersants, detergents, antifoams, color stabilizers, demulsifiers, friction modifiers and antiwear additives.
